(19) United States
(12) Patent Application Publication
(10) Pub. No.: US 2008/0233340 A1
(43) Pub. Date: Sep. 25, 2008

(54) Adhesive Tape for Preventing Implosion of a Cathode Ray Tube and a Process for Reinforcing a Cathode Ray Tube

(76) Inventor: Jose H. Lopes, City Ribeirao - Ribeirao Preto (BR)

Correspondence Address: 3M INNOVATIVE PROPERTIES COMPANY, PO BOX 33427, ST. PAUL, MN, 55133-3427, US

(21) Appl. No.: 12/064,313

(22) PCT Filed: Aug. 14, 2006
(86) PCT No.: PCT/US06/31421

§ 371 Date: Feb. 20, 2008

(30) Foreign Application Priority Data
Aug. 31, 2005 (BR) PI 0503709-3

(51) Int. Cl. C09J 7/02; C09J 5/00

(52) U.S. Cl. 428/111; 427/375

(57) ABSTRACT

The present invention relates to an adhesive tape for preventing implosion of a cathode ray tube. It comprises a polyester backing or polyolefin film, a scrim layer made of glass filament yarns in both directions without yarn torsions in which the junction is made by special adhesive bond and lastly an acrylic pressure sensitive adhesive layer on both sides of the scrim layer.

### TECHNICAL FIELD

The present invention relates to an adhesive tape for preventing implosion of a cathode ray tube (hereafter referred to as “CRT”).

The tape includes a polyester backing or polyolefin film and an acrylic pressure sensitive adhesive layer on both sides of the scrim layer. The scrim is made of glass filament yarns in both directions without yarn torsions. The junction is made by special adhesive bond, where it is used PVC adhesive.

### BACKGROUND OF THE INVENTION

CRTs used in television and other equipment may implode with a minor shock due to the high vacuum inside the tubes. The CRTs can be made resistant to implosion by firmly compressing an outer portion of a CRT by a metal band. However, the metal band is in direct contact with the glass of the CRT and may damage the surface of the glass due to a difference in hardness between the metal and the glass and due to protrusions formed at the welded portions of the metal band. The damage may cause a local reduction in the strength of the CRT. Moreover, the metal band may slip on the curved surface of the CRT and will not hold the CRT at an appropriate position to obtain an effective clamping or supporting effect.

An adhesive layer, including a backing, is inserted between the metal band and the CRT in order to avoid the above-mentioned disadvantages derived from the direct contact of a metal band with the glass of a CRT. This adhesive tape prevents the formation of cracks if a metal band is placed in direct contact with the CRT glass. The adhesive tape can also hold fragments of glass and minimizing the dispersion of the fragments of glass, if the CRT glass is broken.

Conventionally, such an adhesive layer containing a backing is, for example, a double-sided adhesive tape, an epoxy based formulation (see JP-B-40-22338) and so forth. Currently, an adhesive tape containing a glass cloth as the substrate is widely used (see JP-B-63-24291). U.S. Pat. No. 5,478,639 describes an adhesive tape for preventing implosion of cathode ray tube where the tape includes a backing, a pressure sensitive adhesive layer on one side of the backing and a hot melt adhesive layer on the opposite side of the backing. The backing is a cloth comprising natural or synthetic fiber yarns as the warps and glass filament yarns as at least part of the wefts.

Patent U.S. Pat. No. 6,699,801 describes a tape with one mesh of glass cloth and a hot melt adhesive. The aforementioned mesh presents yarn torsions, therefore whereas in our approach the yarns are bonded by adhesive like one screen. The use of the hot melt adhesive may cause the adhesive bond to fail when the CRT is put in an oven to cure the varnish.

Patent U.S. Pat. No. 6,404,121, describes an explosion proof tape composed of support having at least one layer composed of propylene polymer and an adhesive layer formed on one surface of the support in a manner so that a plurality of fiber with a softening point of not lower than 200° C. The problem in this approach is that the conventional process to produce the CRT using to banding the steel band at temperature higher than 200° C. and at this temperature the bonding can be fail and the CRT can loose its protection.

Patent U.S. Pat. No. 5,246,771 describes an adhesive tape for preventing implosion and removing electrostatic charge by adding electrically conductive particles to an adhesive used to prevent an implosion of the tube and located between a metal clamping and the surface of the tube.

The advantage of the present invention over previous approaches is the use of a polyester film or Ethylene Vinyl acetate or polyethylene film which not only provides a flexible backing but it also allows fusion between the metal band and tape backside. The instant invention also provides the possibility of using a metal band as hot source, improving the fusion of the polyester backing and interface resistance. Another advantage is the scrim utilization, which may provide in its constructions a special characteristic, to avoid the breaking of the yarns during the application. Other important point of our invention is the acrylic adhesive used, as is one cross-linked polymer, it can support the stress that can happen during the cooling of the metal band. When implosion-proof tape with the conventional adhesive layer is applied, considerable slippage occurs due to the clamping force caused by cooling contraction of the clamping band that has been expanded by heating, due to fluidity of the adhesive of the implosion-proof tape when it melts and, in severe cases, the reinforcing band may inconveniently fall off together with the implosion-proof tape. In our case, this problem does not happen because the adhesive used is a system that can absorb the mechanical movement.

### SUMMARY OF THE INVENTION

The utilization of glass cloth scrim can avoid the yarns broken during the application process and the cross-linked acrylic adhesive can avoid the failure between metal band and glass surface on the CRT.

The present invention therefore provides the following:

(1) An adhesive glass scrim tape for preventing implosion of a cathode-ray tube, comprising a fabric of yarns in the form of scrim having three main surfaces that are: polyester, EVA or Polyethylene film provided a melting polymer to bond on the metal during the metal clamping process as layer 01, one glass scrim cloth as layer 02 and acrylic adhesive as the layer 03.

(2) The glass scrim adhesive tape according to (1), has a breaking strength of not less than 13 kgf/cm.

(3) The glass scrim adhesive tape comprises wefts and warps at a density in a range of 5 to 10 yarns per 10 mm and with yarns with type 34 dtex. To bond the yarn it is used a PVC thermosetting adhesive.

(5) The glass scrim adhesive tape in which the adhesive coating weight ranges from 60 to 100 grams/m² and the final steel adhesion is of about 500 grams/25 mml.

(6) The polyester film used needs to have a minimum thickness of 0.012 mm and a maximum of 0.036 mm. This is because the thickness needs to be enough to promote the adhesion after the fusion between the metallic band and the CRT. The EVA, PP or PE needs to have one minimum of 0.050 mm and one maximum of 0.100 mm to assurance the bond between the metallic band to the CRT. The difference in the thickness is because the EVA, PP or PE as a thermoplastic system, the fusion will be made at lower temperatures than polyester and the amount to promote the final bond needs to be higher.

### DETAILED DESCRIPTION OF THE INVENTION

The substrate or backing used for the cathode-ray tube implosion-glass scrim tape of the present invention is a scrim fabric, preferably a woven fabric, made through an adhesive bonding process.

The fabric composing the substrate must be able to withstand pressure and temperature between the metal clamping band and the cathode-ray tube. Specifically, when the metal clamping band is shrink-fitted, it is subjected to a pressure of about 5-40 kgf/cm and to temperatures of generally 200° C. or higher, usually 450-650° C., from a few seconds to a few minutes. Therefore it is necessary that the fabric withstands such pressure and high temperatures to remain adhered to the substrate and to prevent direct contact between the metal clamping band and the cathode-ray tube. For example, the yarns of the fabric used must be a monofilament or multi-filament of glass fibers to avoid that the mechanical properties are lost during the heating process. Sometimes the pressure and temperature may reach the scrim's surface and if a synthetic polymer is used, it may be destroyed.

The density of the fabric substrate, in the case of a glass fabric, is such that both the warp and weft are in a range of at least 5 to 10 yarns per 10 mm, and the weaving is preferably accomplished by a weaving method that maintains cloth openings such as a screen weaving. A density of lower than 5 yarns may lead to yarn fraying or loss of texture, and it may not be possible to obtain sufficient strength against implosion of the cathode-ray tube. The kind of yarn is 34 dtex, which presents excellent mechanical properties.

The polymer film used for bonding the metal reinforcing band and the CRT panel may be selected according the process that the customer are using to produce the CRT. When it is used temperatures between 150 to 200° C. the polymer may be chosen from the following group: EVA, polyethylene, or polypropylene, and at this temperature the polymer will softened and melted to promote the adhesion. When the customer process is around 450 to 650° C., polyester film should be used.

The coating weight of the adhesive is preferably in the range of 60 g/m² to 100 g/m² to assurance the ability to hold glass fragments in case of cathode-ray tube implosion.

Acrylic pressure-sensitive adhesives are commonly used due to its high initial adhesion onto the panel and also to its tackiness at room temperatures (10-40° C.). It readily adheres to the outer perimeter of the cathode-ray tube when wrapped around to it, and it does not cause peeling or bubbles even at the corner sections or end joints. The importance of the acrylic adhesive is related to its excellent compatibility to glass fibers, which may avoid the scrim adhesive separation during the life of the product. The rubber-based adhesive did not present a good compatibility with glass and may loose their properties with time.

The tests used to evaluate the performance of the tape are described below.

1. Band (Metal Clamping Band) Shifting

Implosion-proof treatment: After winding one round of a test tape along the outer perimeter side of a flat cathode-ray tube, a metal band ring heated to 450° C. it is fitted thereon for implosion-proof treatment. It is observed whether or not the band slips from the test tape layer by the tensile force of fitting.

After heat cycle: An implosion-proof treated test sample is subjected to 10 cycles of 5 hours at −45° C. Followed by 5 hours at +80° C., and any slipping thereof are observed.

When using the EVA film as polyester replacement, the metal band was heated until 200° C.

2. Adhesive Residue After Humid conditions.

An implosion-proof treated flat cathode-ray tube is immersed for 10 minutes in hot water at 40° C. The bands are then cut and the amount of adhesive residue is examined.

### EXAMPLE 1

A 0.023-mm thick polyester film was coated with a acrylic pressure-sensitive adhesive and thereafter one glass scrim cloth is applied where were used 7 yarns by cm in both directions. Over the scrim IT the same acrylic adhesive was coated. The tape was used on the example of testing 1 and 2.

### EXAMPLE 2

A 0.100 mm of one EVA film was extruded over the glass scrim and it was coated with acrylic pressure sensitive adhesive. The glass scrim used was the same used on the example 1. The tape was used according the testing 1 and 2, but with 200° C.

Table 1 summarizes the results obtained with the tapes described in examples 1 and 2.

| Properties | Example 1 | Example 2 |
|---|---|---|
| Tensile Strength | 14 | 8.0 |
| (kgf/cm · min) | | |
| Elongation (%) | 4 | 12 |
| Adhesion to stainless steel | 0.40 | 0.50 |
| (kgf/cm) | | |
| Thickness (mm) | 0.270 | 0.160 |
| Color | Black | Transparent |

1. An adhesive tape for preventing implosion of a cathode ray tube, characterized by comprising:
i) a backing having three main surfaces: film, scrim cloth and adhesive;
ii) an acrylic pressure sensitive adhesive layer disposed on said first main surface of the backing, and the same adhesive on the third layer disposed on second surface, said backing being glass yarns as the warps and the same glass filament yarns as the wefts;
iii) a density of said warp yarns is 5 to 10 per 10 mm and a density of said weft yarns is 3 to 10 per 10 mm.

2. An adhesive tape according to claim 1, wherein the backing used is a polyester film with 0.012 mm to 0.036 mm of thickness or ethylene-vinyl acetate, polyethylene or polypropylene film with same final thickness.

3. An adhesive tape according to claim 1, wherein said glass filament yarns are 100% of glass yarns, and the design is made by a PVC or ethylene acetate adhesive.

4. An adhesive tape according to claim 1, wherein said acrylic adhesive layer is made of a polymer selected from the reaction of iso-octyl acrylate with acrylic acid with a conversion of 98% and the cure during the coating process is made by bisamide utilization.

5. A process for reinforcing a cathode ray tube for preventing an implosion thereof, characterized by comprising:
the preparation of a cathode ray tube covered with an adhesive tape winding an adhesive tape according to claim 1, completely or partly on or near the portion of the maximum peripheral portion of the cathode ray tube,
clamping the cathode ray tube with a metal clamping band around to the maximum peripheral portion of the tube and on top of the adhesive tape, by heating the metal clamping band to a temperature reaching more than 300° C., and
on this condition the polyester film became one thermosetting adhesive, that has high adhesion to metal band.

6. A process according to claim 5, wherein when the EVA or polyethylene backing is used, heating the metal clamping band must be around to 200° C.
